(19) United States
(12) Patent Application Publication
(10) Pub. No.: US 2011/0093362 A1
(43) Pub. Date: Apr. 21, 2011

(54) ELECTRONIC MEDIA SYSTEM

(76) Inventor: Lorenzo Boston, San Francisco, CA (US)

(21) Appl. No.: 12/869,718

(22) Filed: Aug. 26, 2010

Related U.S. Application Data
(60) Provisional application No. 61/252,785, filed on Oct. 19, 2009.

(51) Int. Cl. G06Q 30/00; G06F 3/048; G06F 13/10; G01S 19/39; G06K 5/00

(52) U.S. Cl. 705/27.1; 715/865; 710/33; 705/26.1; 235/380

(57) ABSTRACT

An Electronic Media System is disclosed herein. The system preferably comprises a terminal, stored electronic data and an accessory unit. The terminal is located in a public location and includes stored electronic data such as downloadable historic and current electronic newspapers and magazines or movies which may be purchased via a slidable magnetic payment means and which may be connectably uploaded to the accessory unit. The hand held accessory unit is purchasable by users and may be used to store and display the downloaded data.

### CROSS-REFERENCE TO RELATED APPLICATION

The present application is related to and claims priority from prior provisional application Ser. No. 61/252,785, filed Oct. 19, 2009 which application is incorporated herein by reference.

### BACKGROUND OF THE INVENTION

1. Field of the Invention

The present invention relates generally to the field of systems for distributing electronic content and more specifically relates to electronic information storage, vending and display apparatuses.

2. Description of the Related Art

While the information age has improved the ability of individuals to transfer information freely and to have instant access to knowledge that would have been difficult or virtually impossible to find previously, a great part of the distribution of newspapers, magazines and other multimedia still happens via traditional outlets, such as stores, kiosks and newsstands.

Unfortunately, the distribution of newspapers and magazines via traditional newsstands is inefficient, not environmentally friendly and costly. Old newspapers and magazines have to be exchanged for new issues on a daily, weekly or monthly basis, which causes a lot of waste and work. The bigger the selection of different magazines at a newsstand is, the more expensive it is to keep all issues up to date, more waste is being created and more space is needed to store and display all the magazines and newspapers. Additionally, the whole procedure of printing, transporting, storing, displaying and finally selling publications is time consuming and costly.

Therefore a need exists for a means to electronically display and sell multimedia at public places and a means on which current and historic multimedia can be downloaded, stored and displayed to reduce the creation of waste and ease the process of selling newspapers and other media.

Various attempts have been made to solve the above-mentioned problems such as those found in U.S. Pat. Nos. 6,381,513, 2002/0143432, 7,209,893, 2001/0037360, and 7,191,399. This prior art is representative of systems for distributing electronic content. None of the above inventions and patents, taken either singly or in combination, is seen to describe the invention as claimed.

Ideally, a system for distributing electronic content should be easy to use, operate reliably and be manufactured at a modest expense. Thus, a need exists for reliable electronic information storage, vending and displaying system to allow a consumer to easily buy electronic newspapers and other media at public places and store and display such media to avoid the above-mentioned problems.

### BRIEF SUMMARY OF THE INVENTION

In view of the foregoing disadvantages inherent in the known systems for distributing electronic content art, the present invention provides a novel system for distributing electronic content. The general purpose of the present invention, which will be described subsequently in greater detail, is to provide reliable electronic information storage, vending and display system which allows a user to readily buy electronic newspapers and other media at public places and to store and display such media on a user owned device.

An Electronic Media System for storing, vending, downloading and displaying multimedia is disclosed herein comprising: at least one terminal which comprises electronic data which may be connectably uploaded and displayed on an accessory unit. The terminal is located in numerous strategic public locations, is decorated with artistic and/or advertising decals, comprises a touch screen and is configured to be handicap compatible.

The terminal further comprises a connection point for the accessory unit or other portable electronic devices to connect and transfer stored electronic data, or alternatively comprises a retractable plug-cable assembly for connection to the accessory unit or other portable electronic devices to connect and transfer stored electronic data. The terminal further comprises a translation means. The Electronic Media System further comprises at least one accessory unit which is purchasable by membership users or non-membership users.

The accessory unit comprises a square, hand held input device with a retractable plug-cable assembly or a connection point for connection to the terminal. Additionally, the accessory unit comprises Global Positioning System means, an on/off switch, a viewing screen, and inputting buttons which may be labeled one through eleven. Each of the operating buttons is programmable to perform a certain function such as access membership log in, search for subjects, save information and read articles. The Electronic Media System further comprises stored electronic data including downloadable historic and current electronic newspapers and magazines which may be purchased via a slidable magnetic payment means or via a daily, monthly, quarterly or yearly payment membership plan and/or downloadable foreign and domestic movies which may be purchased via a slidable magnetic payment means or via a daily, monthly, quarterly or yearly payment membership plan.

Further, a method of purchasing electronic data using an electronic media system is disclosed herein comprising the steps of: purchasing an accessory unit; connecting said accessory unit to a terminal; selecting said electronic data from said terminal via inputting means; downloading selected said electronic data from said terminal into said accessory unit; viewing electronic data on said accessory unit.

The present invention holds significant improvements and serves as an electronic media system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Electronic Media System, constructed and operative according to the teachings of the present invention.

FIG. 1 shows a perspective view illustrating an Electronic Media System in an in-use condition according to an embodiment of the present invention.

FIG. 2 is a perspective view illustrating a terminal of the Electronic Media System according to an embodiment of the present invention of FIG. 1.

FIG. 3 is a perspective view illustrating an accessory unit of the Electronic Media System according to an embodiment of the present invention of FIGS. 1 & 2.

FIG. 4 is a perspective view illustrating a method of use according to an embodiment of the present invention of FIGS. 1-3.

The various embodiments of the present invention will hereinafter be described in conjunction with the appended drawings, wherein like designations denote like elements.

### DETAILED DESCRIPTION

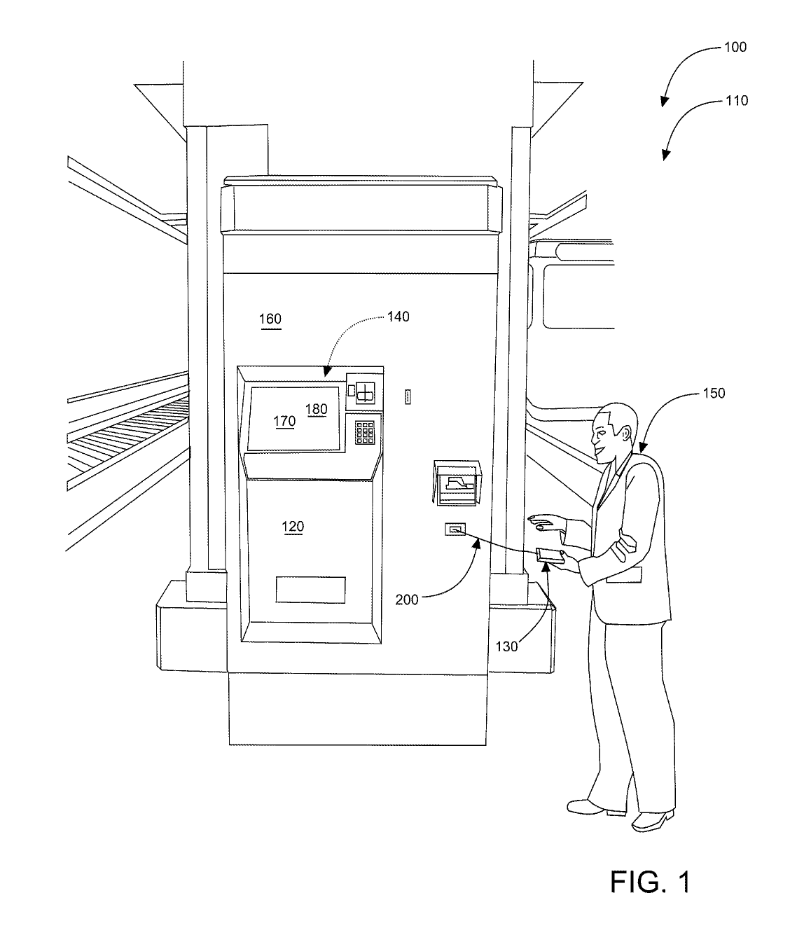

As discussed above, embodiments of the present invention relate to a system for distributing electronic content and more particularly to electronic information storage, vending and display apparatuses as used to improve and facilitate the process of selling multimedia. Referring to the drawings by numerals of reference there is shown in FIG. 1, a perspective view illustrating Electronic Media System 100 in an in-use condition 110 according to an embodiment of the present invention.

Electronic Media System 100 of the present invention preferably comprises at least one terminal 120; at least one accessory unit 130; and stored electronic data 140; wherein terminal 120 comprises stored electronic data 140 which may be connectably uploaded and displayed on accessory unit 130. User 150 may connect accessory unit 130 to terminal 120; select stored electronic data 140 from terminal 120; download selected stored electronic data 140 from terminal 120 into accessory unit 130; and view stored electronic data 140 on accessory unit 130 to create in-use condition 110 as shown in the present figure.

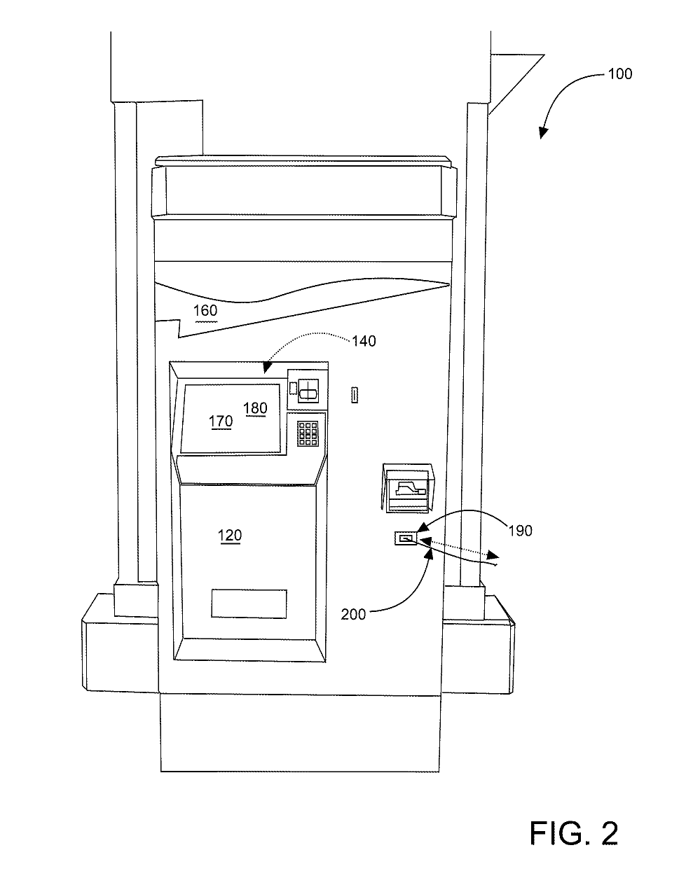

Referring now to FIG. 2, showing a perspective view illustrating terminal 120 of the Electronic Media System 100 according to an embodiment of the present invention of FIG. 1. Terminal 120 of the present invention may preferably be located in numerous strategic public locations, such as shopping malls, theaters, grocery stores, office buildings, hotels and motels, etc. Terminal 120 may further be located at newspaper kiosks, newsstand and bookstores and may virtually replace the traditional newspaper vending racks and booths. Terminal 120 may be located indoors and/or outdoors.

Terminal 120 preferably measures xx in height, xx in depth, and xx in width. Alternatively, terminal 120 may measure xx in height, xx in depth, and xx in width so as to make terminal 120 accessible for shorter people, children, or handicapped people who use wheelchairs. Alternatively, terminal 120 may be height adjustable, allowing access for people of different heights as well as for people with disabilities and those who are wheelchair bound. The above-mentioned heights, lengths, and widths are understood to be exemplary and are not intended to be limiting. Terminal 120 is preferably made of a robust, durable, and weatherproof material, such as plastic, as terminal 120 may be located indoors or outdoors where it will be exposed to elements and extremes in the weather. However, terminal 120 may be comprised of other materials that are durable and weatherproof, such as steel, stainless steel, aluminum, composites, etc. Terminal 120 may be decorated with artistic and/or advertising decals 160 to attract users of various generations and/or to generate income made from advertising. This will ensure that terminal 120 is easily identifiable and that terminal 120 stands out in public places so that potential users instantly recognize and easily find terminal 120.

Terminal 120 further comprises touch screen 170 which may be operated to access stored electronic data 140. Touch screen 170 may measure xx in height by xx in width. Touch screen 170 preferably comprises backlighting and other mechanisms to ensure easy visibility indoors and outdoors. Touch screen 170 preferably comprises a liquid crystal display with fingerprint-resistant and scratch-resistant glass. Touch screen 170 comprises touch sensitive buttons that will be used to select a range of functions including selection of stored electronic data 140. Touch screen 170 thereby facilitates easy user access to an array of multimedia including magazines, newspapers and movies. Touch screen 170 may further be used to select method of payment, to select a language, to cancel entries or to contact customer service. Alternatively, terminal 120 may be operated via hand held mobile selector units which include the same functions as touch screen 170 on terminal 120. Therefore users who chose this option, including those who are wheelchair bound or handicapped will have easier access to terminal 120. Terminal 120 may comprise a customer service function to ease the use of terminal 120. User 150 may use the customer service function to contact a customer service agent if he/she needs to phone in a request for specific stored electronic data 140 or needs other help. Terminal 120 further comprises translation means 180 which allows user 150 to switch operating languages of terminal 120.

Terminal 120 may be monitored with an alarm system to protect terminal 120 from damage caused by vandalism. The alarm system may include a video monitoring device and a motion detector. Terminal 120 in certain embodiments may further comprise a magnetic swipe reader, electronic payment processing software and an online connection. This ensures that payment is received and ratified so that purchased stored electronic data 140 may be transferred and received by user 150.

Terminal 120 further comprises stored electronic data 140. Stored electronic data 140 may comprise downloadable historic and current electronic newspapers and magazines. User 150 will have access to an extensive database of current and historical newspapers and magazines, which may be used for entertainment, education and research tasks. Stored electronic data 140 may further comprise downloadable foreign and domestic movies. This way user 150 will have easy access to a vast array of national and internal movies. However, stored electronic data 140 may comprise various data, such as electronic books, games, etc. Stored electronic data 140 may be purchased via a slidable magnetic payment means or via a daily, monthly, quarterly or yearly payment membership plan. User 150 may purchase a daily, monthly, quarterly or yearly membership at any media store or via the internet, receive a membership card and have the membership card read by the magnetic swipe reader to pay for the transfer of stored electronic data 140 from terminal 120 to accessory unit 130. Alternatively, user 150 may use a conventional credit card to pay for the data transfer.

Terminal 120 further comprises connection point 190 for accessory unit 130 or other portable electronic devices to connect and transfer stored electronic data 140. Connection point 190 may comprise a USB cable inlet. However, connection point 190 may comprise virtually any suitable inlet for a data transfer cable. Alternatively, terminal 120 may comprise retractable plug-cable assembly 200 for connection to accessory unit 130 or other portable electronic devices to connect and transfer stored electronic data 140. Retractable plug-cable assembly 200 may comprise a USB cable. However retractable plug-cable assembly 200 may comprise virtually any suitable data transfer cable that can be used to transfer stored electronic data 140. Connection point 190 and retractable plug-cable assembly 200 may be used to connect terminal 120 to various portable electronic devices, such as Ipods, Ipads, cell phones, etc., which can display electronic data after being equipped with the relevant application or software.

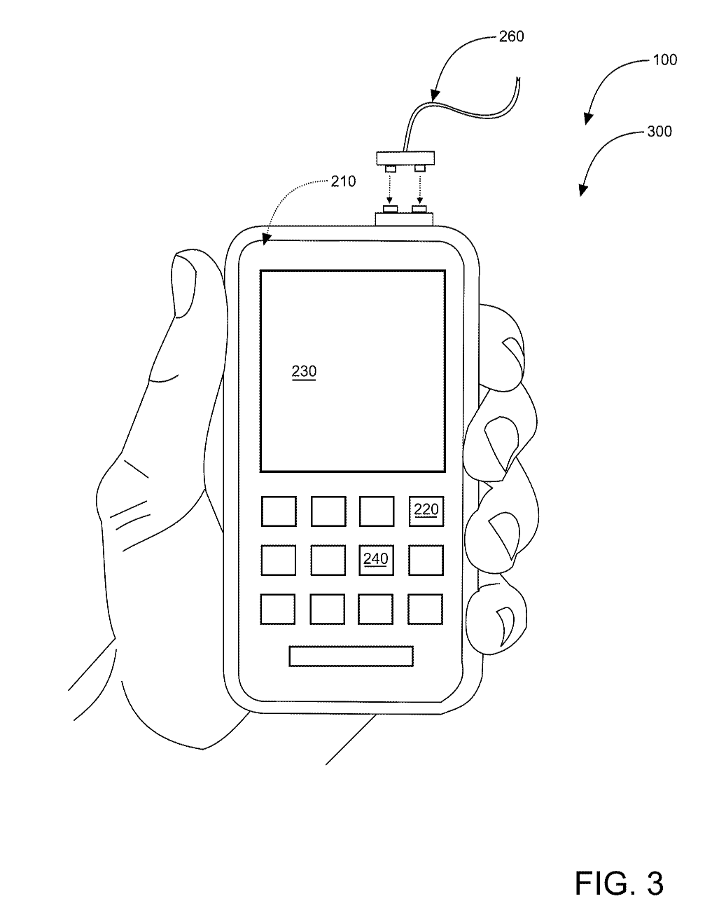

Referring now to FIG. 3, a perspective view illustrating accessory unit of the Electronic Media System according to an embodiment of the present invention of FIGS. 1 & 2.

Accessory unit 130 may be a substantially square, hand held input device comprised of plastic or other suitable materials. Accessory unit 130 may be approximately 8½ inch wide, 14 inch long and 1½ inch high. Accessory unit 130 is purchasable by membership users and non-membership users and may be purchased at any kind of media outlet or via the internet. Accessory unit 130 has the capability to store and display downloaded stored electronic data 140. Accessory unit 130 may comprise the appropriate processor, operating system, and storage capacity to perform the required audio/visual functionality.

Accessory unit 130 comprises a retractable plug-cable assembly 260 for connection to terminal 120. Retractable plug-cable assembly 260 may comprise a USB cable. However retractable plug-cable assembly 260 may comprise any kind of data transfer cable that can be used to transfer stored electronic data 140. Accessory unit 130 alternatively comprises a connection point 250 for connection to terminal 120. Connection point 250 may comprise a USB cable inlet. However, connection point 250 may comprise virtually any suitable inlet for a data transfer cable.

Accessory unit 130 comprises Global Positioning System means 210 and therefore may additionally be used as a GPS device. Accessory unit 130 further comprises a viewing screen 230, which may be approximately 7½ inch long and 11½ inch wide. Viewing screen 230 preferably comprises backlighting and other mechanisms to ensure easy visibility. Viewing screen 230 preferably comprises a liquid crystal display with scratch-resistant glass. Viewing screen 230 may be used to display downloaded newspapers, magazines or movies or other multimedia. On/off switch 220 may be situated on the side of accessory unit 130. Operating buttons 240 may be situated underneath viewing screen 230 and may comprise labeling from one through eleven and may each be programmable to perform a certain function such as access membership log in, search for subjects, save information and read articles. Accessory unit 130 may be battery-operated with either rechargeable or disposable batteries.

Electronic Media System 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other contents or arrangements such as, for example, including more or less components, customized parts, different color combinations, parts may be sold separately, etc., may be sufficient.

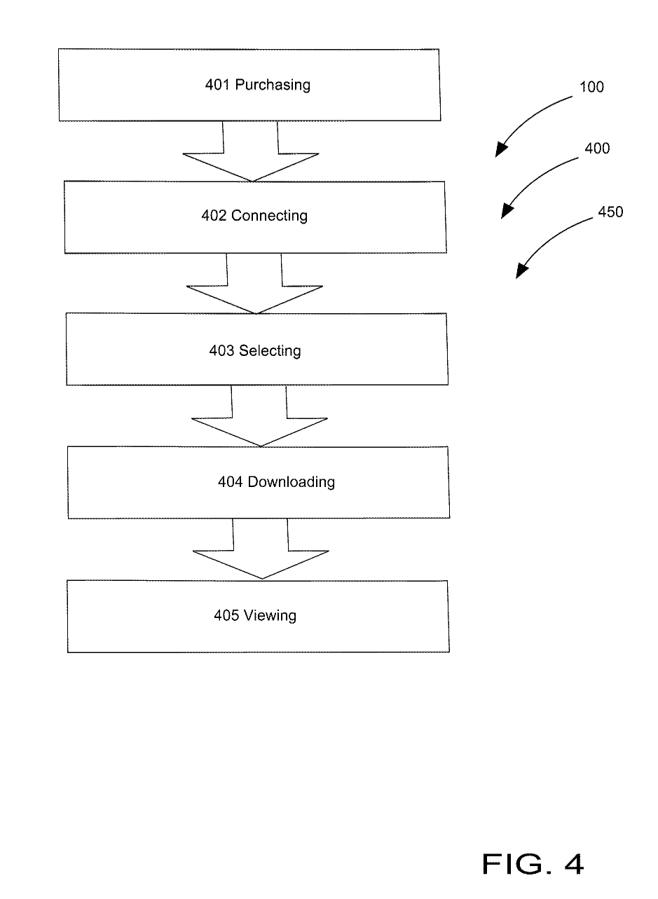

Referring now to FIG. 4, showing flowchart 450, illustrating a method of use 400 according to an embodiment of the present invention of FIGS. 1-3.

In accordance with the embodiments of the present invention a preferred method of use 400 is disclosed herein comprising the following steps: step one 401 purchasing an accessory unit 130; step two 402 connecting accessory unit 130 to terminal 120; step three 403 selecting stored electronic data 140 from terminal 120 via inputting means; step four 404 downloading selected stored electronic data 140 from terminal 120 into accessory unit 130; step five 405 viewing electronic data 140 on accessory unit 130.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An Electronic Media system comprising:
at least one terminal;
at least one accessory unit;
stored electronic data;
wherein said terminal comprises electronic data which may be connectably uploaded and displayed on said accessory unit.

2. The Electronic Media System of claim 1 wherein said terminal may be located in numerous strategic public locations.

3. The Electronic Media System of claim 1 wherein said electronic data comprises downloadable historic and current electronic newspapers and magazines.

4. The Electronic Media System of claim 1 wherein said electronic data comprises downloadable foreign and domestic movies.

5. The Electronic Media System of claim 3 wherein said downloadable historic and current electronic newspapers and magazines may be purchased via a slidable magnetic payment means or via a daily, monthly, quarterly or yearly payment membership plan.

6. The Electronic Media System of claim 4 wherein said foreign and domestic movies may be purchased via a slidable magnetic payment means or via a daily, monthly, quarterly or yearly payment membership plan.

7. The Electronic Media System of claim 1 wherein said terminal is decorated with artistic and/or advertising decals.

8. The Electronic Media System of claim 1 wherein said terminal comprises a touch screen.

9. The Electronic Media System of claim 1 wherein said terminal is configured to be handicap compatible.

10. The Electronic Media System of claim 1 wherein said terminal comprises a connection point for said accessory unit or other portable electronic devices to connect and transfer said stored electronic data.

11. The Electronic Media System of claim 1 wherein said terminal comprises a retractable plug-cable assembly for connection to said accessory unit or other portable electronic devices to connect and transfer said stored electronic data.

12. The Electronic Media System of claim 1 wherein said terminal comprises a translation means.

13. The Electronic Media System of claim 1 wherein said accessory unit is purchasable by membership users.

14. The Electronic Media System of claim 1 wherein said accessory unit is purchasable by non-membership users.

15. The Electronic Media System of claim 1 wherein said accessory unit comprise a square, hand held input device with a retractable plug-cable assembly for connection to said terminal.

16. The Electronic Media System of claim 1 wherein said accessory unit comprise a square, hand held input device with a connection point for connection to said terminal.

17. The Electronic Media System of claim 15 wherein said accessory unit comprises Global Positioning System means, an on/off switch, a viewing screen, and inputting buttons.

18. The Electronic Media System of claim 17 wherein said operating buttons may be labeled one through eleven and each of said operating buttons is programmable to perform a certain function such as access membership log in, search for subjects, save information and read articles.

19. An Electronic Media system comprising:
at least one terminal;
located in numerous strategic public locations,
decorated with artistic and/or advertising decals,
having a touch screen,
being configured to be handicap compatible,
having a connection point for said accessory unit or other portable electronic devices to connect and transfer said stored electronic data,
having a retractable plug-cable assembly for connection to said accessory unit or other portable electronic devices to connect and transfer said stored electronic data,
having a translation means,
at least one accessory unit;
purchasable by membership users,
purchasable by non-membership users,
having a square, hand held input device with a retractable plug-cable assembly for connection to said terminal,
having a square, hand held input device with a connection point for connection to said terminal,
having Global Positioning System means, an on/off switch, a viewing screen, and inputting buttons which may be labeled one through eleven and each of said operating buttons is programmable to perform a certain function such as access membership log in, search for subjects, save information and read articles,
stored electronic data;
including downloadable historic and current electronic newspapers and magazines which may be purchased via a slidable magnetic payment means or via a daily, monthly, quarterly or yearly payment membership plan,
including downloadable foreign and domestic movies which may be purchased via a slidable magnetic payment means or via a daily, monthly, quarterly or yearly payment membership plan,
wherein said terminal comprises electronic data which may be connectably uploaded and displayed on said accessory unit.

20. A method of purchasing electronic data using an electronic media system comprising the steps of:
purchasing an accessory unit;
connecting said accessory unit to a terminal;
selecting said electronic data from said terminal via inputting means;
downloading selected said electronic data from said terminal into said accessory unit;
viewing electronic data on said accessory unit.
